(19) United States
(12) Patent Application Publication
(10) Pub. No.: US 2007/0210961 A1
(43) Pub. Date: Sep. 13, 2007

(54) Detemining location information of network equipment in wireless communication systems

(76) Inventor: Willem Adriaan Romijn, Papendrecht (NL)

Correspondence Address: WILLIAMS, MORGAN & AMERSON, 10333 RICHMOND, SUITE 1100, HOUSTON, TX, 77042, US

(21) Appl. No.: 11/374,340

(22) Filed: Mar. 13, 2006

(51) Int. Cl. G01S 3/02; H04Q 7/20

(52) U.S. Cl. 342/464; 455/456.1

(57) ABSTRACT

A method and an apparatus are provided for determining location information of network equipment in a wireless communication system is provided. The method comprises estimating a parameter indicative of the location information for the network equipment based on a first beacon signal and a second beacon signal The first beacon signal may be detected before the second beacon signal from a transceiver associated with the network equipment and the second beacon signal.

### FIELD OF THE INVENTION

This invention relates generally to telecommunications, and more particularly, to wireless communications.

### DESCRIPTION OF THE RELATED ART

As computing or communication network users become increasingly mobile, wireless usage and capabilities may grow to provide wireless services flexibly and cost effectively by connecting these users to data networks inside or outside of their work or living place. The data networks may wirelessly communicate mobile data at a speed and coverage desired by individual users or enterprises. For example, use of wireless communication devices, such as mobile phones, laptops and Personal Digital Assistants (PDAs) enable users to access public, private or enterprise networks practically everywhere through a wireless local area network (WLAN).

Generally, a wireless LAN includes a wireless access point (AP) that communicates with a network adapter to extend a wired LAN. A user with a Wi-Fi compliant wireless communication device may use any type of access point with any other brand of client hardware that also is based on the IEEE 802.11 standard. Typically, however, any Wi-Fi compliant wireless communication device using the same radio frequency (RF) signal, for example, 2.4 GHz for 802.11 b or 11 g, 5 GHz for 802.11 a may work with any other wireless communication device, even if not a Wi-Fi compliant wireless communication device. The term Wi-Fi, short for wireless fidelity is promulgated by the Wi-Fi Alliance to refer any type of the IEEE 802.11 standard based device or network, whether 802.11 a, 802.11b, 802.11g, dual-band, and the like. The Wi-Fi Alliance is an industry alliance that promotes wireless networking arrangements according to the IEEE 802.11 specification.

A variety of Wi-Fi access points (APs) support the provisioning of multiple virtual networks, identified by a service set identifier (SSID), which is a unique label that distinguishes one WLAN from another. Wireless communication devices generally use the SSID to establish and maintain connectivity. As part of the association process, a wireless network interface card (NIC) should have the same SSID as the access point. An SSID may contain up to 32 alphanumeric characters, which are usually case sensitive. Conventional access points may only support a single SSID. Each SSID may be broadcast or hidden. A broadcast SSID allows a mobile terminal with a Wi-Fi receiver (“client”) to detect and identify that network. The Wi-Fi client software, such as available with Microsoft® Windows™ XP Operating System may allow the client to connect to “visible” networks, i.e., with broadcasted SSIDs for an available access point.

Increasingly mobile computing depends upon location of a device. For example, to a user of laptop or a personal digital assistant (PDA) or a cell phone, the location of the portable wireless communication device may determine whether a particular type and certain quality of a wireless service is available. To provide a location-based wireless service to mobile devices, wireless communication systems that comply with Institute of Electrical and Electronics Engineers (IEEE) 802.11 standard based or Global System for Mobile communications (GSM) may provide beacons in a radio beacon-based location approach to enable a wireless service. However, in many wireless communication systems, different factors determine whether a particular infrastructure may provide or enable the wireless service for a user or network equipment. For example, in a cell-based wireless communication system, such as a digital cellular system, physical position of a wireless communication device may enable a service within a coverage area, such as within a business building or campus. In an outdoor environments, different factors contribute to the signal strength that the wireless communication device may receive and transmit.

One location system involves use of expensive infrastructure and time consuming calibration to determine location of a wireless communication or mobile device for allowing users or clients of notebooks, personal digital assistants (PDAs) and cell phones to locate themselves by listening for radio beacons such as IEEE 802.11 access points (APS), GSM cell phone towers and fixed Bluetooth devices that already exist in an environment. Such beacons may use unique or semi-unique identifiers (IDs). One example of a beacon identifier is a Medium Access Control address. A user or client may compute its location by listening to one or more beacon identifiers, looking up the associated beacons' positions in a locally cashed map, and estimating its own position referenced to the beacon's positions.

Many cellular providers may compute and offer the locations of the mobile devices on a wireless network using a global positioning system (GPS). However, having a limited coverage possible, a GPS receiver-based location system is generally insufficient for a desired coverage goal. That is, while having high availability as measured by the percent of earth's surface covered, have poor coverage measured by the percent of time GPS receivers work where most people spend most of their time. Most GPS receivers may only operate outdoors since a clear view of sky is desired, therefore, fail to provide coverage indoors or underground.

A variety of device positioning systems use IEEE 802.11 access points as beacons from which to estimate location. Other similar systems may use specific radio sources in the environment including GSM based cell towers. Some indoor location systems use ultrasonic, infrared, ultra-wide band radio signals for beacons. However, such location positioning system for wireless devices include installation of hardware and software infrastructure and constant monitoring, which is generally expensive.

One approach to address this problem involves using radio beacons in an environment, databases (dBs) that hold information about beacons' locations, and the clients that use this data to estimate their current location. By listening for transmissions of wireless networking sources, like IEEE 802.11 access points, fixed Bluetooth devices, and GSM cell towers, wireless or mobile devices may detect unique or semi-unique identifiers in radio beacons.

A database may be maintained to store estimated physical location information of network equipment, such as a wireless communication or client device. The physical location information may include latitude and/or longitude information based on beacon signals, examples of beacon signals include cell identifiers for a GSM system or a service set identifier (SSID) for a wireless local area network (WLAN). Since the databases contain available estimated physical location information, i.e., latitude/longitude information of the user network equipment based on beacon signals like cell identifiers (GSM) or SSIDs (WLAN), inaccuracy of this information provides inaccurate beacon information.

One conventional method of determining the location of a client wireless device is based on listening for a beacon signal and measuring signal strength for a given signal on different locations and predicting a possible location of the transmitter of the signal. These predicted locations are stored in a database that can be queried at later time by location based applications. However this method is inherently inaccurate because, although the current location is accurate, the stored predicted locations are estimates. This method stores the predicted location of the transmitter. The stored predicted location indicates new beacon information. By predicting the location of the transmitter of the beacon signal, current location is determined. At most, only a limited accuracy for location-based systems is obtained.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of, one or more of the problems set forth above.

In one embodiment of the present invention, a method and apparatus of determining location information of network equipment in a wireless communication system is provided. The method comprises estimating a parameter indicative of the location information for the network equipment based on a first beacon signal and a second beacon signal from a transceiver associated with the network equipment. The first beacon signal being detected before the second beacon signal.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a wireless communication system that includes user network equipment which may communicate with a wireless network to determine its location information according to one embodiment of the present invention;

FIG. 2 is schematically illustrates a flow diagram for determining the current location information based on the location(s) where measurements of network transitions are taken consistent with one embodiment of the present invention;

FIG. 3 schematically illustrates a flow diagram of a circle including a plurality of measured location(s) and a calculated location coordinate of the user network equipment according to one illustrative embodiment of the present invention; and

FIG. 4 schematically illustrates a stylized representation for determining the location information of the user network equipment in the wireless network shown in FIG. 1 in the wireless communication system in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

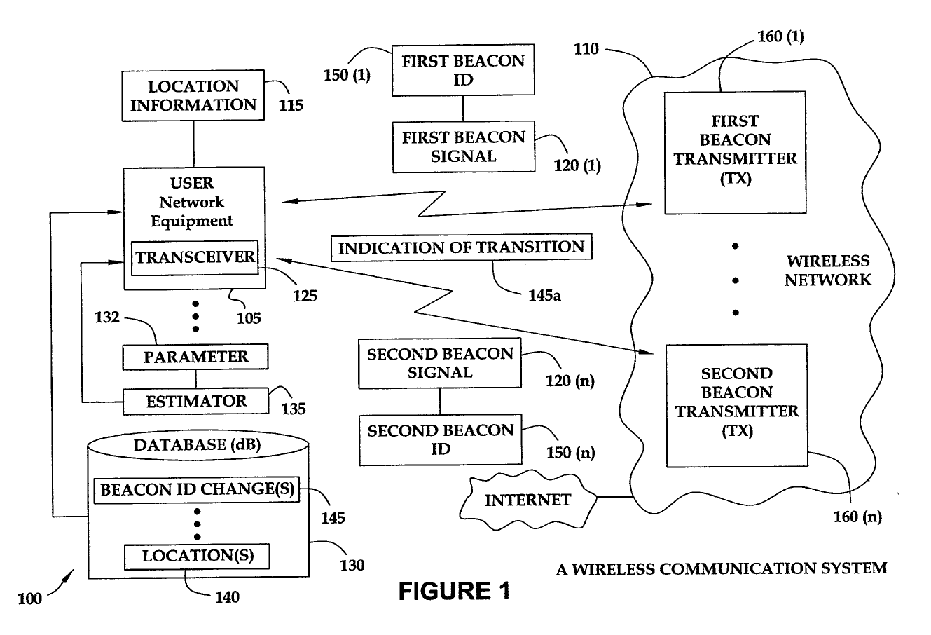

Referring to FIG. 1, a wireless communication system 100 is shown to include user network equipment 105 that may communicate with a wireless network 110 to determine its location information 115 according to one embodiment of the present invention. To determine the location information 115, the user network equipment 105 may estimate the physical location information based on at least two radio beacons. The radio beacons may include a first beacon signal 120(l) detected before a second beacon signal 120(n) from a transceiver 125 associated with the user network equipment 105. In this way, instead of estimating parameter 132 indicative of the location information 115 such as the physical location information of the user network equipment 105 based on the first beacon signal 120(l) from the transceiver 125, an estimate of the location information 115 may be based on the first beacon signal 120(1) detected before the second beacon signal 120(n) from the transceiver 125.

More specifically, when the user network equipment 105, such as a cell phone moves out of a cell, the signal strength decreases and continues to decrease for that cell and the signal strength in a neighboring cell continues to increase. The decreasing of the signal strength is one of the reasons why a new beacon signal may be detected by the user network equipment 105. When the neighbor cell signal strength is strong enough, the cell phone, such as the user network equipment 105 may change its association to the new cell and receive a new cell identifier. The new cell identifier may indicate the reception of the new beacon signal.

In one embodiment of the present invention, the location information 115 may indicate the location where a new beacon, the second beacon signal 120(n) is detected by the user network equipment 105. The location information 115 associated with the new beacon may be stored in a database 130 with the location information of an old beacon the first beacon signal 120(l). That is, in one embodiment, the user network equipment 105 may comprise an estimator 135. The estimator 135 may store the location information 115 for the 5 user network equipment 105 in the database 130. In this way, for the user network equipment 105 a plurality of locations 140 may be stored in the database 130 as the locations where a beacon is detected. In addition to the locations 140, the database 130 may store beacon identifier (ID) change(s) 145 for the user network equipment 105.

In particular, a first beacon identifier (ID) 150 (l) may be received at the user network equipment 105. The first beacon identifier (ID) 150 (l) may indicate detection of the first beacon signal 120(l). Likewise, a second beacon identifier (ID) 150(n) may indicate detection of the second beacon signal 120(n) at the user network equipment 105.

The user network equipment 105 may use the beacon ID changes 145 to provide an indication of transition 145(a) to a first beacon transmitter (TX) 160(l) associated with the wireless network 110. The wireless network 110 may further comprise a second beacon transmitter (TX) 160(n) to provide a beacon signal, such as the second beacon signal 120(n) for a new cell to the user network equipment 105. For example, the first beacon transmitter 160(l)may be associated with a cell in a wireless communication network such as a digital cellular network. Alternatively, the first beacon transmitter 160(l)may be associated with a wireless access point (AP) of the wireless network 110.

By communicating with an access point associated with a high frequency WLAN, the wireless network 110 may offer a wireless service, in the wireless communication system 100. A wireless communication-enabled device may use wireless connectivity available to a first user, i.e., in a broadband connection.

Instead of storing the predicted location of the transceiver 125, the estimator 135 may store the location information 115 where a new beacon is detected. Examples are a cell change in GSM or a WLAN SSID change. The old and new beacon identifiers, i.e., the first and second beacon IDs 120(l, n) may be stored in beacon ID change(s) 145 entries together with the current location in the locations(s) 140 entries in the database 130. In this way, the estimator 135 may increase the accuracy of this information by taking the previous beacon information into account.

Thus, rather than predicting the location of the transceiver 125 of a beacon signal, the position where the user network equipment 105 is located is detected to estimate the parameter 130 indicative of the current location information. To determine the current location information a triangulation process may be used. Alternatively, the estimator 135 may determine the current location information based on previous measurements with the same beacon transition by averaging the previous (exact) locations. In this way, a significantly increased accuracy for location based systems may be obtained in some embodiments.

To determine the location of the user network equipment 105, the database (dB) 130 may be formed with characteristics for prediction. When the database 130 has been established, the first beacon transmitter may query the user network equipment 105 by inputting the first beacon id 150(l), and in response, receiving location information 115. Both current method and the invention use the same approach. The database (dB) 130 may store the beacon ID change(s) 145 (from one ID and to another ID) and the location(s) 140.

Examples of the wireless communication system 110 include the 3rd generation (3G) mobile communication system, namely Universal Mobile Telecommunication System (UMTS) supports multimedia services according to 3rd Generation Partnership Project (3GPP) specifications. The UMTS also referred as Wideband Code Division Multiple Access (WCDMA) includes Core Networks (CN) that are packet switched networks, e.g., IP-based networks.

According to one embodiment, the wireless network 110 may comprise one or more data networks, such an Internet Protocol (IP) network comprising the Internet and a public telephone system (PSTN). To provide an end-to-end service to users, for example, a UMTS network may deploy a UMTS bearer service layered architecture specified by Third Generation Project Partnership (3GPP) standard. The provision of the end-to-end service is conveyed over several networks and realized by the interaction of the protocol layers.

The user network equipment 105 may be a fixed location or a mobile device and incorporate wireless protocols, such as IEEE 802.11 , IEEE 802.11a, IEEE 802.11b, Bluetooth, or the like for communicating with a network, such as a wireless local area network. The user network equipment 105 may be in data communication with a server through the access point(s). The access point(s) may communicate with the server over an Ethernet wired network. The transmission and reception of data may use a TCP/IP protocol, and the wireless network 110 may be connected to the Internet 112. Each of the wireless communication device(s) may associate with one of the access point(s). Each access point may determine which of the communications received over the Ethernet link from a server is destined for a specific wireless communication device associated with that particular access point.

In one embodiment, a public Wi-Fi hotspot which refers to a single point within a cell or a sector where a relatively large number of users of a multiplicity of mobile terminals may gather in a relatively small area, for example, an audience gathered in an auditorium or a cafe may be used for wireless communications. To communicate, one or more wireless routers may use a variety of identification schemes to resolve IP addresses for the purposes of routing packets in an IP network. An IP network may comprise logical layers from application to physical layers for network elements to provide an end-to-end service for network traffic. The IP network may carry signaling traffic on a single channel, stream or packet data.

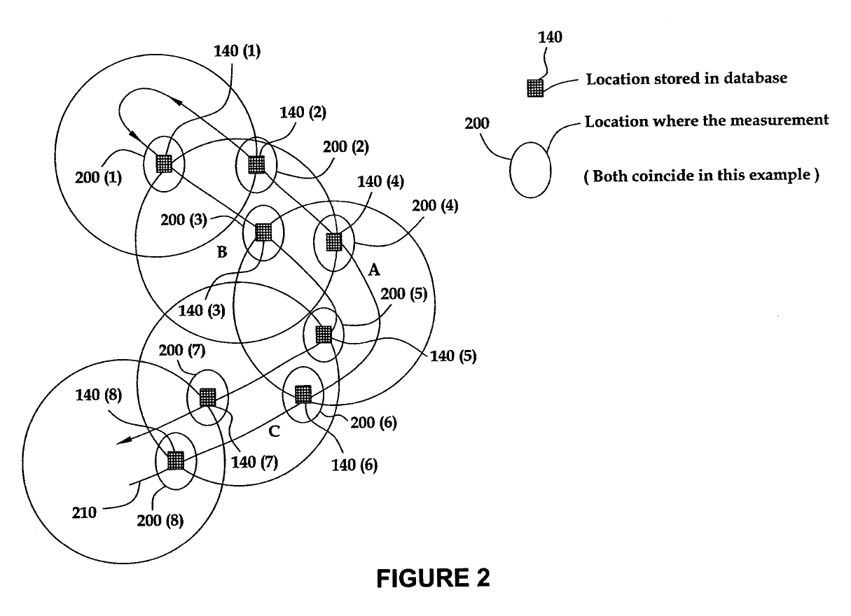

Referring to FIG. 2, a flow diagram for determining the current location information 115 based on the location(s) 140(1-8) where measurements 200 of network transitions are taken is schematically illustrated in accordance with one embodiment of the present invention. Eight measurements 200(1-8) are illustrated to be taken each time a circle 205, such as a cell coverage area is entered and from that three locations are calculated (the dots on the circle are used to predict the center of the circle). When more measurements are taken, a predicted location 210 may move towards the center of each of the circle 205.

The eight measurements 200(1-8) may result in eight locations in the database 130. When more measurements 200 are taken, the accuracy decreases but the probability that a user, such as the user of the user network equipment 105 being inside the calculated circle around all measurements increases. That is, it remains inside the calculated circle based on the eight location(s) 140 (1-8). There are more locations 140 stored in the database 130 but the current location information 115 is determined based on known locations instead of the predicted ones.

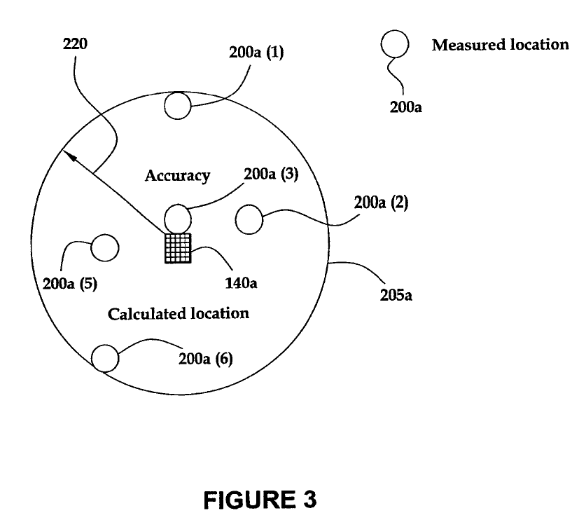

Referring to FIG. 3, a flow diagram of a circle 205a including a plurality of measured location(s) 200a (1-5) and a calculated location coordinate 140a of the user network equipment 105 is schematically illustrated in accordance with one embodiment of the present invention. An indication for accuracy 220 of prediction of location of the user network equipment 105 is indicated as the calculated location coordinate 140a surrounded with a circle 205a. According to one embodiment of the present invention, the exact location of the user network equipment 105 may lie within the circle 205a.

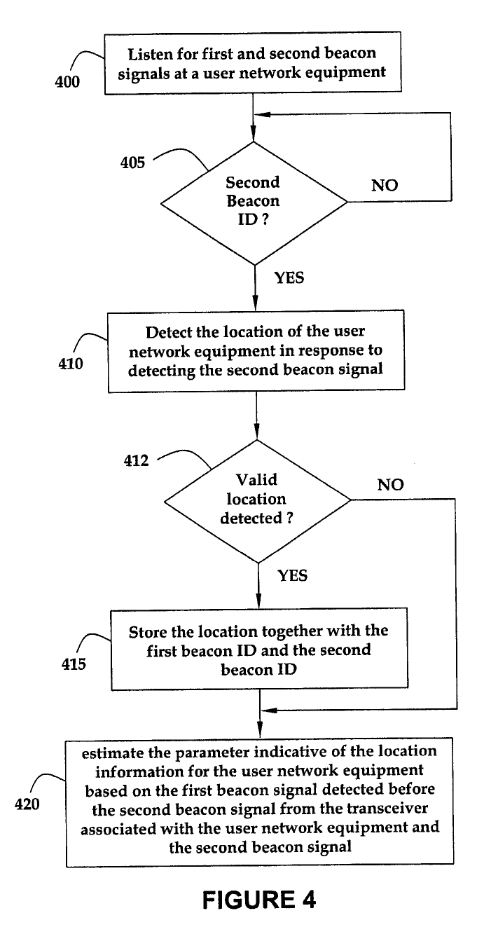

Referring to FIG. 4, a method of determining the location information 115 of the user network equipment 105 in the wireless network 110 shown in FIG. 1 in the wireless communication system 100 is schematically illustrated in accordance with one embodiment of the present invention. At block 400, the estimator 135 may listen for the first and second beacon signals 120(l, n). A decision block 405 may ascertain whether the second beacon ID 150(n) is detected by the estimator 135. At block 410, the estimator 135 may detect the location of the second beacon signal 120(n) based on the second beacon ID 150(n). A decision block 412 may ascertain whether a valid location is detected. At block 415, the location of second beacon signal 120(n) together with the first beacon ID 150(l)and the second beacon ID 150(n) is stored.

At block 420, the estimator 135 may estimate the parameter 132 indicative of the location information 115 for the user network equipment 105 based on the first beacon signal 120(l)detected before the second beacon signal 120(n) from the transceiver 125 associated with the user network equipment 105 and the second beacon signal 120(n).

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11 (a), 802.11 (b), 802.11 (g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of determining location information of network equipment in a wireless communication system, the method comprising:
estimating information indicative of a physical location of said network equipment based on a first beacon signal and a second beacon signal from a transceiver associated with said network equipment, said first beacon signal being detected before said second beacon signal.

2. A method, as set forth in claim 1, wherein estimating a information indicative of a physical location of said network equipment further comprising:
listening for said first and second beacon signals;
detecting a location of said network equipment based on said second beacon signal; and
storing said information indicative of the physical location with previously determined information indicative of the physical location of said network equipment.

3. A method, as set forth in claim 1, wherein further comprising:
using current location information for said network equipment based on said first and second beacon signals.

4. A method, as set forth in claim 3, wherein using current location information further comprises:
using physical location information of said network element, wherein said physical location information including at least one of physical information, latitude and longitude information.

5. A method, as set forth in claim 1, further comprising:
determining a cell identifier associated with said first and second beacon signals.

6. A method, as set forth in claim 1, further comprising:
determining a service set identifier associated with said first and second beacon signals.

7. A method, as set forth in claim 1, further comprising:
detecting a new beacon for said second beacon signal; and
in response to detecting said new beacon, storing the information indicative of the physical location of said network equipment.

8. A method, as set forth in claim 7, wherein detecting a new beacon further comprises:
detecting an indication of a network transition in said wireless communication system.

9. A method, as set forth in claim 8, wherein detecting an indication of a network transition further comprises:
detecting a change in a cell identifier in one of a GSM and UMTS system.

10. A method, as set forth in claim 9, wherein detecting a change in a cell identifier further comprises:
storing an old identifier associated with said first beacon signal and a new identifier associated with said second beacon signal together with current information indicative of the physical location of said network element.

11. A method, as set forth in claim 8, wherein detecting an indication of a network transition further comprises:
detecting a change in a service set identifier in a wireless local area network.

12. A method, as set forth in claim 11, wherein detecting a change in a service set identifier further comprises:
storing an old identifier associated with said first beacon signal and a new identifier associated with said second beacon signal together with current location information of said network element.

13. A method, as set forth in claim 1, further comprising:
using an indication of transition from a first beacon transmitter associated with said network equipment to a second beacon transmitter to determine said location information of said network equipment.

14. A method, as set forth in claim 13, further comprising:
determining said information indicative of the physical location of the network equipment based on triangulation.

15. A method, as set forth in claim 14, further comprising:
determining current information indicative of the physical location of said network equipment based on one or more previous measurements with the same beacon transition between said first and second beacon signals by averaging said one or more previous measurements instead of said triangulation.
